(19) United States
(12) Patent Application Publication
(10) Pub. No.: US 2007/0171394 A1
(43) Pub. Date: Jul. 26, 2007

(54) Flagstick with integrated reflectors for use with a laser range finder

(76) Inventors: Daniel Steiner, Waunakee, WI (US); Rob O'Loughlin, Madison, WI (US); Wayne Timberman, Carmel, IN (US); Michael Plitman, Minneapolis, MN (US)

Correspondence Address: FOLEY & LARDNER LLP, 150 EAST GILMAN STREET, P.O. BOX 1497, MADISON, WI, 53701-1497, US

(21) Appl. No.: 11/339,417

(22) Filed: Jan. 25, 2006

(51) Int. Cl. G01C 3/08

(52) U.S. Cl. 356/5.01; 356/4.01

(57) ABSTRACT

A system is provided for determining a distance to a target. In an exemplary embodiment, the system includes a pole and a distance measuring device. The pole includes a plurality of sockets formed in a surface of the pole above a selected lower reflecting point and a reflector mounted in each of the plurality of sockets. The lower reflecting point defines a minimum distance from a first end of the pole above which the reflectors are located for use with the distance measuring device. At least a portion of a signal received from the distance measuring device is reflected back to the distance measuring device by a receiving reflector. The distance measuring device includes a transmitter that transmits the signal at a first time, a receptor that receives the reflected signal from the receiving reflector at a second time, and a processor to determine the distance from the transmitter to the receiving reflector using the first time and the second time.

### FIELD OF THE INVENTION

The present invention is related to systems for determining a distance to an object. More specifically, the present invention relates to a plurality of reflectors integrated with a flagstick, and the use of laser light to calculate a distance from a laser light source to the location of one of the plurality of reflectors.

### BACKGROUND OF THE INVENTION

Laser light can be used to measure the distance from a laser light source to a target object. To measure distance, a laser transmits pulses of light toward an intended target. The light is reflected from the target and is received by a receptor. A calculation is made to determine the distance to the target based on the elapsed travel time between the transmission of the pulse of light and the reception of the reflected pulse of light. To improve performance, a reflector can be mounted to the target object to reflect a higher percentage of the transmitted light towards the receptor. For example, as disclosed in U.S. patent application Ser. No. 10/931,947, filed Sep. 1, 2004, entitled FLAGPOLE REFLECTORS FOR LASER RANGE FINDERS, and assigned to the assignee of the present application, a reflector device can be mounted in a pole. Such an arrangement provides for a determination of the distance from the laser light source to the pole. U.S. patent application Ser. No. 10/931,947 is hereby incorporated by reference in its entirety.

Mounting a reflector device to the pole increases the weight of the pole, forms a discernible seam where the reflector device mounts to the pole, increases the height of the pole, and may form a pronounced bump or indentation in the pole if the diameter of the reflector device is different than the pole diameter. Additionally, using some reflector device mounting designs, glue is used to keep the reflector device mounted to the pole. Failure of the glue results in a broken pole. What is needed, therefore, is a method and a system for reliably providing a reflector mounted in a pole while maintaining the weight, diameter, height, and shape of the pole.

### SUMMARY OF THE INVENTION

An exemplary embodiment of the invention provides a system and a method for providing a plurality of reflectors mounted in a pole without increasing the diameter, height, or shape of the pole and insignificantly changing the weight of the pole. Each of the plurality of reflectors is mounted in the pole individually by drilling appropriately sized and shaped sockets in the pole. Failure of the mounting of the reflectors in the sockets does not result in a broken pole.

An exemplary embodiment of the invention relates to a method for making a pole that includes reflectors wherein the pole is used in a distance measuring system. The method includes providing a pole having a first end and a second end, the second end opposite the first end, selecting a lower reflecting point between the first end and the second end, forming a plurality of sockets in a surface of the pole above the selected lower reflecting point, and mounting a reflector in each of the plurality of formed sockets. The lower reflecting point defines a minimum distance from the first end above which a reflector is located for use with a distance measuring device

Another exemplary embodiment of the invention relates to a device for reflecting signals toward a distance measuring device. The device includes a pole having a first end and a second end, the second end opposite the first end, a plurality of sockets formed in a surface of the pole above a selected lower reflecting point and a reflector mounted in each of the plurality of sockets. The lower reflecting point defines a minimum distance from the first end above which the reflectors are located for use with a distance measuring device. At least a portion of a signal received from the distance measuring device is reflected back to the distance measuring device by a receiving reflector, wherein the receiving reflector is one of the reflectors.

Still another exemplary embodiment of the invention relates to a system for determining a distance to a target. The system includes a pole and a distance measuring device. The pole has a first end and a second end and includes a plurality of sockets formed in a surface of the pole above a selected lower reflecting point and a reflector mounted in each of the plurality of sockets. The lower reflecting point defines a minimum distance from the first end above which the reflectors are located for use with a distance measuring device. At least a portion of a signal received from the distance measuring device is reflected back to the distance measuring device by a receiving reflector, wherein the receiving reflector is one of the reflectors. The distance measuring device includes a transmitter that transmits the signal at a first time, a receptor that receives the reflected signal from the receiving reflector at a second time, and a processor to determine the distance from the transmitter to the receiving reflector using the first time and the second time.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements. The objects shown in the figures may not be drawn to the same scale.

FIG. 1 is a system diagram of a distance measuring system in accordance with an exemplary embodiment.

FIG. 2 illustrates the structure of an exemplary reflector of the distance measuring system of FIG. 1.

FIG. 3 is a diagram illustrating laser light reception and reflection paths for the exemplary reflector of FIG. 2.

FIG. 4 is a first side view of a first exemplary reflector arrangement for the distance measuring system of FIG. 1.

FIG. 5 is a second side view of the first exemplary reflector arrangement rotated approximately 90 degrees with respect to the first side view of FIG. 4.

FIG. 6 is a third side view of the first exemplary reflector arrangement rotated approximately 180 degrees with respect to the first side view of FIG. 4.

FIG. 7 is a fourth side view of the first exemplary reflector arrangement rotated approximately 270 degrees with respect to the first side view of FIG. 4.

FIG. 8 is a first side view of a second exemplary reflector arrangement for the distance measuring system of FIG. 1.

FIG. 9 is a second side view of the second exemplary reflector arrangement rotated approximately 90 degrees with respect to the first side view of FIG. 8.

FIG. 10 is a first side view of a third exemplary reflector arrangement for the distance measuring system of FIG. 1.

FIG. 11 is a second side view of the third exemplary reflector arrangement rotated approximately 72 degrees with respect to the first side view of FIG. 10.

FIG. 12 is a third side view of the third exemplary reflector arrangement rotated approximately 144 degrees with respect to the first side view of FIG. 10.

FIG. 13 is a first side view of a fourth exemplary reflector arrangement for the distance measuring system of FIG. 1.

FIG. 14 is a second side view of the fourth exemplary reflector arrangement rotated approximately 72 degrees with respect to the first side view of FIG. 13.

FIG. 15 is a third side view of the fourth exemplary reflector arrangement rotated approximately 144 degrees with respect to the first side view of FIG. 13.

### DETAILED DESCRIPTION OF EXEMPLARY EMBODIMENTS

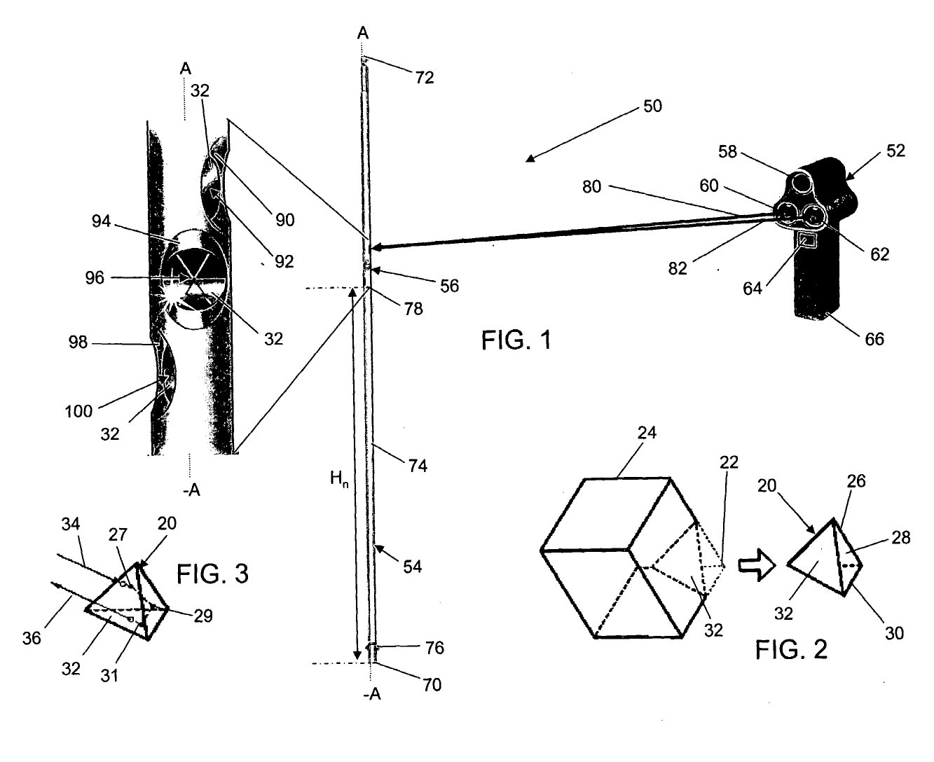

With reference to FIG. 1, a distance measuring system 50 is shown in accordance with an exemplary embodiment. Distance measuring system 50 includes, but is not limited to, a laser range finder 52 and a pole 54. The laser range finder 52 may include an aiming light source 58, a laser light source 60, a laser light receptor 62, a measurement button 64, a handle 66, and a processor (not shown). The aiming light source 58 transmits a light, for example a red light, toward a current aiming point so that the user can visually identify where the laser range finder 52 is currently aimed. The laser light source 60 transmits laser light toward the current aiming point when the measurement button 64 is depressed by the user. For example, laser light source 60 transmits light along a transmission path 80 toward the pole 54. In an exemplary embodiment, the laser light may be transmitted in a series of pulses. The laser light source 60 may be a Class 1 laser as known to those skilled in the art. The laser light receptor 62 receives laser light reflected back toward the laser range finder 52. For example, the laser light receptor 62 receives light reflected along a reception path 82. The handle 66 provides the user with a grasping point for the laser range finder 52 and provides access to the measurement button 64 while keeping the hands of the user away from the laser light source 60 and the laser light receptor 62. The handle 66 may be held in the palm of the user's hand. Thus, in an exemplary embodiment, the laser range finder 52 is handheld.

In the exemplary embodiment of FIG. 1, the pole 54 may include a first end 70, a second end 72, a pole surface 74, and a flange 76. The first end 70 provides a surface to support the pole 54. For example, the first end 70 is placed in a cup cut into the green of a golf hole. The flange 76 may be placed near the first end 70 to provide additional support for the pole 54, for example, when the first end 70 of the pole 54 is placed in the cup. The second end 72 is opposite the first end 70. The pole surface 74 includes a reflector portion 56. The pole may be hollow or solid. The pole 54 may be formed of a single or multiple materials. The material that forms the pole 54 includes rigid and semi-rigid materials such as wood, fiberglass, plastic, metal, aluminum, etc. The circumference of the pole surface 74 may form any shape including, but not limited to, circular, square, triangular, rectangular, hexagonal, elliptical, etc.

With reference to FIG. 2, a corner cube reflector 20 is shown. The corner cube reflector 20 is cut from a corner 22 of a cube 24. The cube 24 may be formed of glass or other reflective material. The corner cube reflector 20 has a first face 26, a second face 28, a third face 30, and a fourth face 32. Each of the first face 26, the second face 28, and the third face 30 is parallel to a different side of the cube 24 that share the corner 22. Thus, the first face 26, the second face 28, and the third face 30 are mutually orthogonal to each other. Exemplary reflector diameters are 9 millimeters (mm) and 12 mm.

With reference to FIG. 3, transmitted laser light 34, for example traveling along transmission path 80, passes through the fourth face 32. In the example of FIG. 3, the transmitted laser light 34 strikes the first face 26 at a first point 27 and is reflected toward the second face 28. The light reflected at the first point 27 strikes the second face 28 at a second point 29 and is reflected toward the third face 30. The light reflected at the second point 29 strikes the third face 30 at a third point 31 and is reflected toward the laser light receptor 62. For example, reflected laser light 36, reflected at the third point 31, travels along reception path 82 toward laser light receptor 62. Thus, in general, the transmitted laser light 34 received at the corner cube reflector 20 undergoes three internal reflections, one reflection from each of the three mutually orthogonal faces 26, 28, 30. After the reflection from the third face, the laser light 36 is reflected in the opposite direction of the transmitted laser light 34. In an exemplary embodiment, the fourth face 32 of corner cube reflector 20 is 12 mm in diameter.

As known to those skilled in the art, the reflection path within the reflector 20 varies depending on where the transmitted laser light 34 breaks the plane of the fourth face 32 and the angle that the transmitted laser light 34 makes with respect to the fourth face 32. Thus, the retro-reflective behavior of the corner cube reflector 20 is independent of the orientation angle between the corner cube reflector and the laser light incident on the fourth face 32. The retro-reflective behavior depends only on the accuracy of the squareness of the corner 22. As known to those skilled in the art, corner cube reflectors may also be known as a corner cube, a trihedral retro-reflector, a trihedral prism, a corner cube prism, and/or a corner cube retro-reflector.

The reflector portion 56 includes a plurality of reflectors. In an exemplary embodiment, each reflector of the reflector portion 56 is a corner cube reflector 20. Use of the corner cube reflector 20 increases the amount of laser light that is reflected back toward the laser light receptor 62 by reducing the amount of laser light that would otherwise be scattered in directions other than back toward the laser range finder 52. The plurality of reflectors may be formed from glass or other similarly reflective material. The plurality of reflectors are arranged to receive the laser light from the laser light source 60 and to reflect laser light back towards the laser light receptor 62.

In the exemplary embodiment of FIG. 1, the reflector portion 56 is formed in the pole 54 between a lower reflecting point 78 and the second end 72. The placement of the plurality of reflectors around the circumference of the pole surface 74 and between the lower reflecting point 78 and the second end 72 is determined based on the number and size of the reflectors. The number and size of the reflectors may be determined based on the diameter of the pole 54, the maximum distance from the laser range finder 52 to the pole 54, and the potential angular locations of the laser range finder 52 with respect to the pole 54.

The lower reflecting point 78 defines a minimum distance Hₙ for locating the reflector portion 56 relative to the first end 70. The minimum distance Hₙ is determined based on the application of the distance measuring system 50 and the need for a direct line of sight between the handheld laser range finder 52 and a reflector of the reflector portion 56. Thus, reflector portion 56 should be mounted a sufficient distance above the first end 70 to allow a laser range finder 52 to aim at one of the plurality of reflectors from the desired distance without obstruction from the ground. Additionally, the reflector portion 56 should be mounted a sufficient distance above or below any other obstructions. For example, the pole 54 may have a flag attached near the second end 72. If so, the reflector portion 56 should be mounted such that the flag will not cover any of the plurality of reflectors. In an exemplary embodiment wherein the pole 54 is a flagstick placed in a cup of a golf hole, Hₙ is in the range of approximately 52-118 inches. For specialty flagsticks, Hₙ may be in the range of approximately 40-125 inches. These ranges are provided as examples and are not intended to limit the placement of the reflectors for other uses. The plurality of reflectors may be arranged in the pole surface 74 between the lower reflecting point 78 and the second end 72.

In the exemplary embodiment of FIG. 1, the reflector portion 56 includes a first reflector 92, a second reflector 96, a third reflector 100, and a fourth reflector 104 (shown in FIG. 7). The first reflector 92 is mounted in a first socket 90 with the fourth face 32 directed away from the interior of the first socket 90. As used in this disclosure, the term “mount” includes join, unite, connect, associate, insert, hang, hold, affix, attach, fasten, bind, paste, secure, bolt, screw, rivet, solder, weld, glue, friction fit, and other like terms. The second reflector 96 is mounted in a second socket 94 with the fourth face 32 directed away from the interior of the second socket 94. The third reflector 100 is mounted in a third socket 98 with the fourth face 32 directed away from the interior of the third socket 98. The fourth reflector 104 is mounted in a fourth socket 102 with the fourth face 32 directed away from the interior of the fourth socket 102 (shown in FIGS. 6 and 7). In an exemplary embodiment, each reflector 92, 96, 100, 104 is mounted and held in the respective socket 90, 94, 98, 102 using glue. The first socket 90, the second socket 94, the third socket 98, and the fourth socket 102 are sized and shaped to accommodate the first reflector 92, the second reflector 96, the third reflector 100, and the fourth reflector 104, respectively. In an exemplary embodiment, the first socket 90, the second socket 94, the third socket 98, and the fourth socket 102 include a beveled edge.

In an exemplary embodiment, the pole 54 is formed of fiberglass. The first socket 90, the second socket 94, the third socket 98, and the fourth socket 102 are formed by drilling holes in the pole surface 74. The holes define a reflector arrangement. In an exemplary embodiment, the hole is a circular hole with an oval shaped counter-bore on the outside. To avoid splintering of the pole, an appropriate drill bit and drill speed combination is selected based on the pole material and the size/shape of the holes and the size of the flagstick in the dimension that the reflectors are placed. For example, to form a hole for a 12 mm reflector, a one inch drill bit operated at a drill bit speed of at least approximately 1500 revolutions per minute forms a smooth socket with a beveled edge in a 0.5 inch diameter fiberglass pole without splintering. Exemplary pole diameters are 0.5, ⅝, and 0.75 inches. Exemplary hole diameters for a 12 mm reflector are in the range of approximately 0.508-0.514 inches with a hole depth of approximately 0.245 inches. A 0.56 counter-bore may be formed on the pole 54 surface using a 90 degree chamfer around all or a portion of the hole. Exemplary hole diameters for a 9 mm reflector are in the range of approximately 0.385-0.390 inches with a hole depth of approximately 0.2 inches. Again, a counter-bore may be formed on the pole 54 surface using a 90 degree chamfer around all or a portion of the hole. Testing has demonstrated that a pole 54 formed of fiberglass does not result in increased breakage due to normal use as a result of the holes drilled in the pole surface 74.

To use the distance measuring system 50, a user aims the laser range finder 52 at the reflector portion 56 formed in the pole 54 using the aiming light source 58. The user depresses the measurement button 64 to determine the distance from the laser range finder 52 to the pole 54. In an exemplary embodiment, the laser light source 60 transmits pulses of laser light toward at least one of the reflectors 92, 96, 100, 104 at a first time. At least one of the reflectors 92, 96, 100, 104 of the reflector portion 56 receives the transmitted laser light pulses. The reflector receiving the transmitted laser light pulses reflects the laser light back toward the laser light receptor 62 as described with reference to FIG. 3. The laser light receptor 62 receives the reflected laser light from the light reflector at a second time. Using the processor, the laser range finder 52 determines the distance from the laser range finder 52 to the reflector receiving the laser light based on the time difference between the first time and the second time divided by two times the speed of light. The processor may be implemented in hardware, firmware, software, or any combination of these methods.

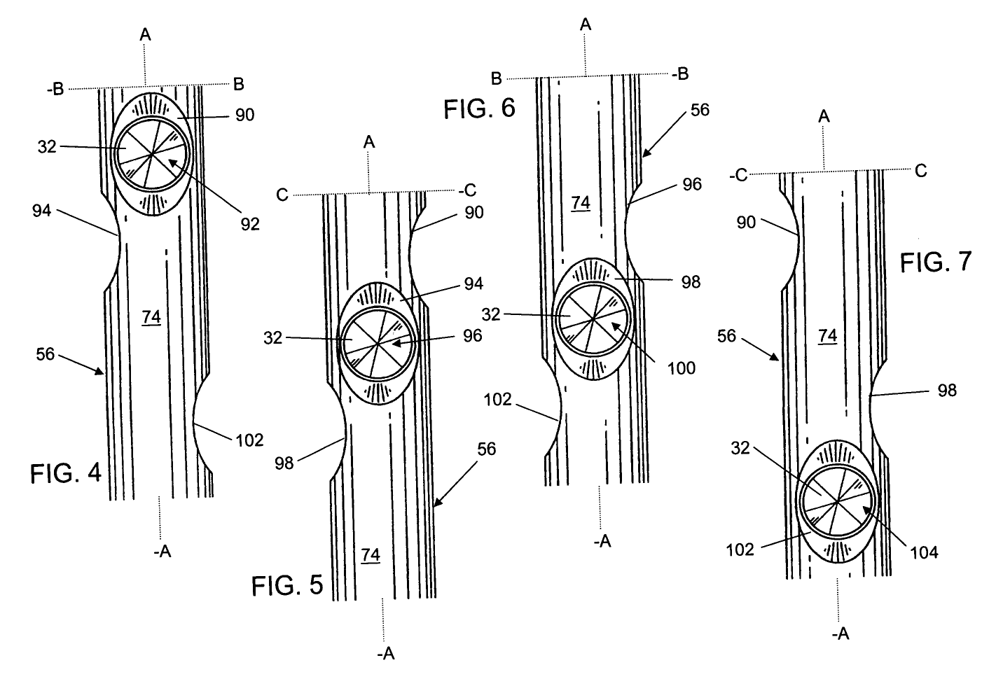

With reference to FIGS. 4-7, an arrangement of the plurality of reflectors is shown in a first exemplary embodiment of a reflector portion 56. The first socket 90, the second socket 94, the third socket 98, and the fourth socket 102 are formed in the pole surface 74. First reflector 92, second reflector 96, third reflector 100, and fourth reflector 104 are mounted in the first socket 90, the second socket 94, the third socket 98, and the fourth socket 102, respectively.

With reference to FIG. 4, an axis A-A extends in a longitudinal direction from the first end 70 to the second end 72 and through a center of the pole surface 74. The positive A-A axis direction is from the first end 70 to the second end 72. An axis B-B is perpendicular to the axis A-A and extends in a lateral direction through the center of the pole surface 74. The positive B-B axis direction is indicated in FIG. 4 with negative B oriented to the left and positive B oriented to the right. An axis C-C is perpendicular to both axis A-A and axis B-B to form a right-handed coordinate reference system. Thus, the positive C-C axis direction for the side view of FIG. 4 is into the page. The positive C-C axis direction also is indicated in FIG. 5 with negative C oriented to the right and positive C oriented to the left. Thus, a positive rotation of axis B-B into axis C-C results in a counterclockwise rotation about A-A as viewed from the second end 72.

In the first exemplary embodiment of FIGS. 4-7, the sockets 90, 94, 98, 102 are arranged in a longitudinal stack such that each reflector is located in a separate row where sockets in a row have a common longitudinal distance from either the first end 70 and/or the second end 72 along the axis A-A. The reflectors 92, 96, 100, 104 are arranged to provide 360 degrees of coverage relative to rotation about the axis A-A. Thus, the laser light transmitted from the laser range finder 52 reflects from at least one reflector 92, 96, 100, 104 regardless of the pointing direction from the laser range finder 52 to the pole 54.

With reference to FIG. 4, the fourth face 32 of the first reflector 92 points out of the page in the negative direction of axis C-C. With reference to FIG. 5, the pole surface 74 is rotated approximately 90 degrees about the axis A-A relative to FIG. 4. With reference to FIG. 5, the fourth face 32 of the second reflector 96 points out of the page in the negative direction of axis B-B. With reference to FIG. 6, the pole surface 74 is rotated approximately 90 degrees about the axis A-A relative to FIG. 5. With reference to FIG. 6, the fourth face 32 of the third reflector 100 points out of the page in the positive direction of axis C-C. With reference to FIG. 7, the pole surface 74 is rotated approximately 90 degrees about the axis A-A relative to FIG. 6. With reference to FIG. 7, the fourth face 32 of the fourth reflector 104 points out of the page in the positive direction of axis B-B. Thus, in the first exemplary embodiment of FIGS. 4-7, the reflectors 92, 96, 100, 104 are arranged in a “barber-pole” fashion.

The longitudinal separation between the reflectors 92, 96, 100, 104 may be greater or less than indicated in the FIGS. 4-7 depending on such factors as the circumference of the pole, the size of the reflectors, etc. In an exemplary embodiment, the centers of each reflector 92, 96, 100, 104 are separated longitudinally along the C-C axis by approximately 1.625 inches using 12 mm reflectors and a pole 54 having a diameter of either ⅝ inches or 0.75 inches. In an alternative embodiment, the reflectors 92, 96, 100, 104 may be arranged such that adjacent reflectors are oriented in 90 degree steps when the pole surface 74 is rotated in a clockwise direction. In other alternative embodiments, the reflectors 92, 96, 100, 104 may be arranged such that a reflector is oriented in a direction that is 180 degrees different from an adjacent reflector. In still other alternative embodiments, the reflectors may be oriented in directions that differ by a different number of degrees to provide angular coverage overlap between the reflectors 92, 96, 100, 104 and/or to provide less than 360 degrees of angular coverage.

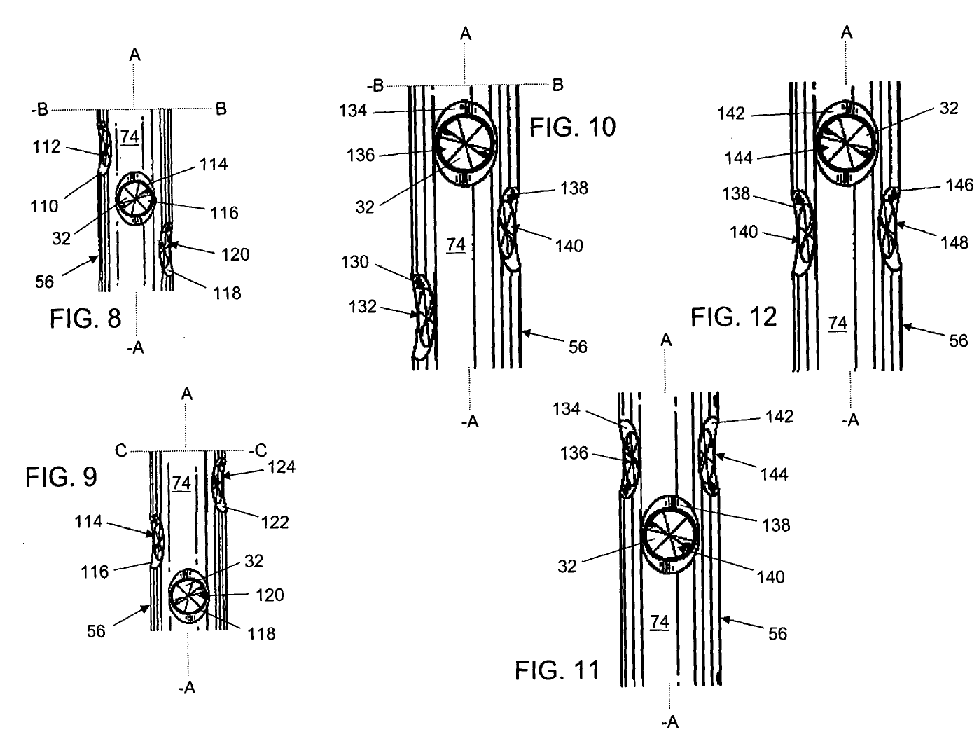

With reference to FIGS. 8 and 9, an arrangement of the plurality of reflectors is shown in a second exemplary embodiment of a reflector portion 56. The second exemplary embodiment utilizes four reflectors each mounted in a socket drilled into the pole surface 74. Thus, a first socket 110, a second socket 114, a third socket 118, and a fourth socket 122 are formed in the pole surface 74. A first reflector 112, a second reflector 116, a third reflector 120, and a fourth reflector 124 are mounted in the first socket 110, the second socket 114, the third socket 118, and the fourth socket 122, respectively.

An axis A-A extends in a longitudinal direction from the first end 70 to the second end 72 and through a center of the pole surface 74. The positive A-A axis direction is from the first end 70 to the second end 72. An axis B-B is perpendicular to the axis A-A and extends in a lateral direction through the center of the pole surface 74. The positive B-B axis direction is indicated in FIG. 8 with negative B oriented to the left and positive B oriented to the right. An axis C-C is perpendicular to both axis A-A and axis B-B to form a right-handed coordinate reference system. The positive C-C axis direction for the side view of FIG. 8 is into the page. The positive C-C axis direction also is indicated in FIG. 9 with negative C oriented to the right and positive C oriented to the left. Thus, a positive rotation of axis B-B into axis C-C results in a counterclockwise rotation about A-A as viewed from the second end 72.

In the second exemplary embodiment of FIGS. 8 and 9, the sockets 110, 114, 118, 122 are arranged to provide 360 degrees of coverage relative to rotation about the axis A-A. Thus, the laser light transmitted from the laser range finder 52 reflects from at least one reflector 112, 116, 120, 124 regardless of the pointing direction from the laser range finder 52 to the pole 54.

With reference to FIG. 8, the fourth face 32 of the second reflector 116 points out of the page in the negative direction of axis C-C. The first reflector 112 is located at a greater distance from the first end 70 than the second reflector 116 and points in a direction approximately −90 degrees from the second reflector 116. The third reflector 120 is located at a lesser distance from the first end 70 than the second reflector 116 and points in a direction approximately 90 degrees from the second reflector 116.

With reference to FIG. 9, the pole surface 74 is rotated approximately 90 degrees about the axis A-A relative to FIG. 8. The fourth face 32 of the third reflector 120 points out of the page. The second reflector 116 points in a direction approximately −90 degrees from the third reflector 120. The fourth reflector 124 is located at approximately the same distance from the first end 70 as the first reflector 112 and points in a direction approximately 90 degrees from the third reflector 120.

The longitudinal separation between the reflectors 112, 116, 120, 124 may be greater or less than indicated in the FIGS. 8 and 9 depending on such factors as the circumference of the pole, the size of the reflectors, etc. In an exemplary embodiment, the centers of each reflector 112, 116, 120, 124 may be separated longitudinally along the C-C axis by approximately 1.625 inches using 12 mm reflectors and a pole 54 having a diameter of either ⅝ inches or 0.75 inches. In an alternative embodiment, the reflectors 112, 116, 120, 124 may be arranged such that adjacent reflectors are oriented in 90 degree steps when the pole surface 74 is rotated in a clockwise direction. In other alternative embodiments, the reflectors may be oriented in directions that differ by a different number of degrees to provide angular coverage overlap between the reflectors 112, 116, 120, 124 and/or to provide less than 360 degrees of angular coverage. In still other alternative embodiments, the reflector 114 may be located at approximately the same distance from the first end 70 as the first reflector 120 or vice versa. More than two sockets/reflectors may be arranged in a single row (at approximately the same distance from the first end 70). The number of sockets mountable in a single row generally is constrained by the size of the reflector and the circumference of the pole 54.

With reference to FIGS. 10-12, an arrangement of the plurality of reflectors is shown in a third exemplary embodiment of a reflector portion 56. The third exemplary embodiment utilizes five reflectors each mounted in a socket drilled into the pole surface 74. Thus, a first socket 130, a second socket 134, a third socket 138, a fourth socket 142, and a fifth socket 146 are formed in the pole surface 74. A first reflector 132, a second reflector 136, a third reflector 140, a fourth reflector 144, and a fifth reflector 148 are mounted in the first socket 130, the second socket 134, the third socket 138, the fourth socket 142, and the fifth socket 146, respectively.

An axis A-A extends in a longitudinal direction from the first end 70 to the second end 72 and through a center of the pole surface 74. The positive A-A axis direction is from the first end 70 to the second end 72. An axis B-B is perpendicular to the axis A-A and extends in a lateral direction through the center of the pole surface 74. The positive B-B axis direction is indicated in FIG. 10 with negative B oriented to the left and positive B oriented to the right. An axis C-C (not shown) is perpendicular to both axis A-A and axis B-B to form a right-handed coordinate reference system. The positive C-C axis direction for the side view of FIG. 10 is into the page. Thus, a positive rotation of axis B-B into axis C-C results in a counterclockwise rotation about A-A as viewed from the second end 72.

In the third exemplary embodiment of FIGS. 10-12, the sockets 130, 134, 138, 142, 146 are arranged to provide 360 degrees of coverage relative to rotation about the axis A-A. Thus, the laser light transmitted from the laser range finder 52 reflects from at least one reflector 132, 136, 140, 144, 148 regardless of the pointing direction from the laser range finder 52 to the pole 54.

With reference to FIG. 10, the fourth face 32 of the second reflector 136 points out of the page in the negative direction of axis C-C. The third reflector 140 is located at a lesser distance from the first end 70 than the second reflector 136 and points in a direction approximately 72 degrees from the second reflector 136. The first reflector 132 is located at a lesser distance from the first end 70 than the third reflector 140 and points in a direction approximately −72 degrees from the second reflector 136.

With reference to FIG. 11, the pole surface 74 is rotated approximately 72 degrees about the axis A-A relative to FIG. 10. The fourth face 32 of the third reflector 140 points out of the page. The second reflector 136 points in a direction approximately −72 degrees from the third reflector 140. The fourth reflector 144 is located at approximately the same distance from the first end 70 as the second reflector 136 and points in a direction approximately 72 degrees from the third reflector 140.

With reference to FIG. 12, the pole surface 74 is rotated approximately 72 degrees about the axis A-A relative to FIG. 11. The fourth face 32 of the fourth reflector 144 points out of the page. The third reflector 140 points in a direction approximately −72 degrees from the third fourth reflector 144. The fifth reflector 148 is located at approximately the same distance from the first end 70 as the third reflector 140 and points in a direction approximately 72 degrees from the fourth reflector 144.

The longitudinal separation between the reflectors 132, 136, 140, 144, 148 may be greater or less than indicated in the FIGS. 10-12 depending on such factors as the circumference of the pole, the size of the reflectors, etc. In an exemplary embodiment, the centers of each reflector 132, 136, 140, 144, 148 may be separated longitudinally along the C-C axis by approximately 1.625 inches using 12 mm reflectors and a pole 54 having a diameter of either ⅝ inches or 0.75 inches. In an alternative embodiment, the reflectors 132, 136, 140, 144, 148 may be arranged such that adjacent reflectors are oriented in 72 degree steps when the pole surface 74 is rotated in a clockwise direction. In other alternative embodiments, the reflectors may be oriented in directions that differ by a different number of degrees to provide angular coverage overlap between the reflectors 132, 136, 140, 144, 148 and/or to provide less than 360 degrees of angular coverage. More than two sockets/reflectors may be arranged in a single row (at approximately the same distance from the first end 70). In other alternative embodiments, reflector 132 may be located at a greater distance from the first end 70 than the second reflector 136, the third reflector 140, the fourth reflector 144, and/or the fifth reflector 148.

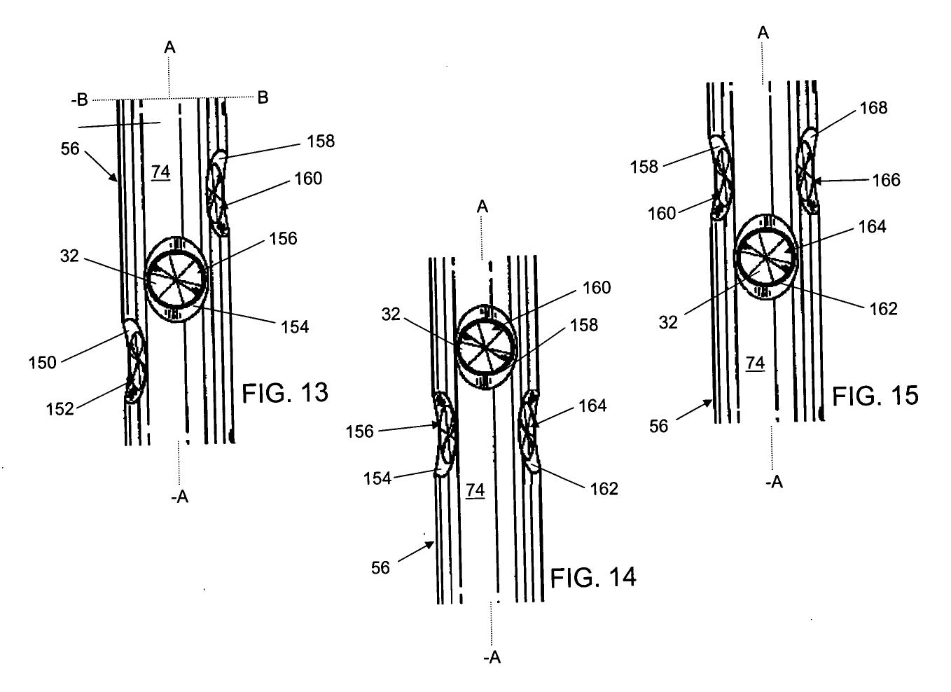

With reference to FIGS. 13-15, an arrangement of the plurality of reflectors is shown in a fourth exemplary embodiment of a reflector portion 56. The fourth exemplary embodiment utilizes five reflectors each mounted in a socket drilled into the pole surface 74. Thus, a first socket 150, a second socket 154, a third socket 158, a fourth socket 162, and a fifth socket 166 are formed in the pole surface 74. A first reflector 152, a second reflector 156, a third reflector 160, a fourth reflector 164, and a fifth reflector 168 are mounted in the first socket 150, the second socket 154, the third socket 158, the fourth socket 162, and the fifth socket 166, respectively.

An axis A-A extends in a longitudinal direction from the first end 70 to the second end 72 and through a center of the pole surface 74. The positive A-A axis direction is from the first end 70 to the second end 72. An axis B-B is perpendicular to the axis A-A and extends in a lateral direction through the center of the pole surface 74. The positive B-B axis direction is indicated in FIG. 13 with negative B oriented to the left and positive B oriented to the right. An axis C-C (not shown) is perpendicular to both axis A-A and axis B-B to form a right-handed coordinate reference system. The positive C-C axis direction for the side view of FIG. 13 is into the page. Thus, a positive rotation of axis B-B into axis C-C results in a counterclockwise rotation about A-A as viewed from the second end 72.

In the fourth exemplary embodiment of FIGS. 13-15, the sockets 150, 154, 158, 162, 166 are arranged to provide 360 degrees of coverage relative to rotation about the axis A-A. Thus, the laser light transmitted from the laser range finder 52 reflects from at least one reflector 152, 156, 160, 164, 168 regardless of the pointing direction from the laser range finder 52 to the pole 54.

With reference to FIG. 13, the fourth face 32 of the second reflector 156 points out of the page in the negative direction of axis C-C. The third reflector 160 is located at a greater distance from the first end 70 than the second reflector 156 and points in a direction approximately 72 degrees from the second reflector 156. The first reflector 152 is located at a lesser distance from the first end 70 than the second reflector 156 and points in a direction approximately −72 degrees from the second reflector 156.

With reference to FIG. 14, the pole surface 74 is rotated approximately 72 degrees about the axis A-A relative to FIG. 13. The fourth face 32 of the third reflector 160 points out of the page. The second reflector 156 points in a direction approximately −72 degrees from the third reflector 160. The fourth reflector 164 is located at approximately the same distance from the first end 70 as the second reflector 156 and points in a direction approximately 72 degrees from the third reflector 160.

With reference to FIG. 15, the pole surface 74 is rotated approximately 72 degrees about the axis A-A relative to FIG. 14. The fourth face 32 of the fourth reflector 164 points out of the page. The third reflector 160 points in a direction approximately −72 degrees from the third fourth reflector 164. The fifth reflector 168 is located at approximately the same distance from the first end 70 as the third reflector 160 and points in a direction approximately 72 degrees from the fourth reflector 164.

The longitudinal separation between the reflectors 152, 156, 160, 164, 168 may be greater or less than indicated in the FIGS. 13-15 depending on such factors as the circumference of the pole, the size of the reflectors, etc. In an exemplary embodiment, the centers of each reflector 152, 156, 160, 164, 168 may be separated longitudinally along the C-C axis by approximately 1.625 inches using 12 mm reflectors and a pole 54 having a diameter of either ⅝ inches or 0.75 inches. In an alternative embodiment, the reflectors 152, 156, 160, 164, 168 may be arranged such that adjacent reflectors are oriented in 72 degree steps when the pole surface 74 is rotated in a clockwise direction. In other alternative embodiments, the reflectors may be oriented in directions that differ by a different number of degrees to provide angular coverage overlap between the reflectors 152, 156, 160, 164, 168 and/or to provide less than 360 degrees of angular coverage. More than two sockets/reflectors may be arranged in a single row (at approximately the same distance from the first end 70). In other alternative embodiments, reflector 152 may be located at a greater distance from the first end 70 than the second reflector 156, the third reflector 160, the fourth reflector 164, and/or the fifth reflector 168.

In an example use case for the distance measuring system 50, the reflector portion is integrated into a flagstick used to mark the location of a golf cup on the green of a golf hole. The golfer utilizes a handheld laser range finder pointed at the reflector portion of the flagstick to determine the distance to the golf cup. Because the golfer may approach the green from a variety of directions and because the flagstick may be placed in the cup with the reflectors pointed in different directions, 360 degrees of angular coverage for the reflectors is desired. Integration of the reflectors into the pole, instead of insertion or placement of a reflector device on the pole, reduces the weight and the height of the resulting pole, improves the appearance of the pole, maintains the circumference of the pole, and reduces the potential for breakage of the pole due to a failure at the insertion point of the reflector device. Tests have shown that normal, regular use on a golf course of the flagstick with an integrated reflector portion does not result in increased breakage of the flagstick due to the sockets drilled into the flagstick. Loss of a reflector from a socket does not result in a broken flagstick and may not result in a failure of the distance measuring system.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. For example, the reflectors may be distributed in innumerable arrangements between the lower reflecting point 78 and the second end 72 of the pole 54 all in different rows or all in the same row or in any other combination. As an additional example, six reflectors may be formed between the lower reflecting point 78 and the second end 72 of the pole 54. Six reflectors may be oriented in 60 degree steps. In alternative embodiments, a 9 mm diameter reflector can be used. For example, using a 9 mm diameter reflector, the centers of each reflector may be separated longitudinally along the C-C axis by approximately 1.32 inches using a pole having a diameter of ⅝ inches. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for making a pole that includes reflectors wherein the pole is used in a distance measuring system, the method comprising:
providing a pole having a first end and a second end, the second end opposite the first end;
selecting a lower reflecting point between the first end and the second end, the lower reflecting point defining a minimum distance from the first end above which a reflector is located for use with a distance measuring device;
forming a plurality of sockets in a surface of the pole above the selected lower reflecting point; and
mounting a plurality of reflectors in at least two of the plurality of formed sockets.

2. The method of claim 1, wherein the distance measuring device is a laser range finder.

3. The method of claim 1, wherein the reflector is a corner cube reflector.

4. The method of claim 1, wherein forming the plurality of sockets comprises drilling the sockets into the pole.

5. The method of claim 4, wherein the pole is formed of fiberglass.

6. The method of claim 5, wherein drilling the sockets utilizes an approximately one inch drill bit.

7. The method of claim 5, wherein drilling the sockets utilizes a drill speed of at least approximately 1500 revolutions per minute.

8. A device for reflecting signals toward a distance measuring device, the device comprising:
a pole having a first end and a second end, the second end opposite the first end;
a plurality of sockets formed in a surface of the pole above a selected lower reflecting point; and
a plurality of reflectors mounted in at least two of the plurality of formed sockets, wherein the lower reflecting point defines a minimum distance from the first end above which the reflectors are located for use with a distance measuring device, and further wherein at least a portion of a signal received from the distance measuring device is reflected back to the distance measuring device by a receiving reflector, wherein the receiving reflector is one of the reflectors.

9. The device of claim 8, wherein the distance measuring device is a laser range finder.

10. The device of claim 8, wherein the reflector is a corner cube reflector.

11. The device of claim 8, wherein the pole is formed of fiberglass.

12. The device of claim 8, further comprising at least four sockets.

13. The device of claim 8, wherein the plurality of sockets are each formed at a different longitudinal distance from the first end of the pole.

14. The device of claim 8, wherein at least one of the plurality of sockets is formed at a first longitudinal distance from the first end of the pole and at least one of the plurality of sockets is formed at a second longitudinal distance from the first end of the pole, and further wherein the first longitudinal distance and the second longitudinal distance are different.

15. The device of claim 8, wherein at least two of the plurality of sockets are formed at approximately the same longitudinal distance from the first end of the pole.

16. A system for determining a distance to a target, the system comprising:
a pole having a first end and a second end, the second end opposite the first end, the pole comprising
a plurality of sockets formed in a surface of the pole above a selected lower reflecting point; and
a plurality of reflectors mounted in at least two of the plurality of formed sockets, wherein the lower reflecting point defines a minimum distance from the first end above which the reflectors are located for use with a distance measuring device, and further wherein at least a portion of a signal received from the distance measuring device is reflected back to the distance measuring device by a receiving reflector, wherein the receiving reflector is one of the reflectors; and
a distance measuring device, the distance measuring device comprising
a transmitter that transmits the signal at a first time;
a receptor that receives the reflected signal from the receiving reflector at a second time; and
a processor to determine the distance from the transmitter to the receiving reflector using the first time and the second time.

17. The system of claim 16, wherein the distance measuring device is a laser range finder.

18. The system of claim 16, wherein the pole is formed of fiberglass.

19. The system of claim 16, wherein the plurality of sockets are each formed at a different longitudinal distance from the first end of the pole.

20. The system of claim 16, wherein at least two of the plurality of sockets are formed at approximately the same longitudinal distance from the first end of the pole.
